(19) United States
(12) Patent Application Publication
(10) Pub. No.: US 2013/0146532 A1
(43) Pub. Date: Jun. 13, 2013

(54) FEED SPACER FOR SPIRAL WOUND MEMBRANE ELEMENT

(71) Applicants: Prasanna Rao DONTULA, Bangalore (IN); Yatin TAYALIA, Singapore (SG); Upen Jayant BHARWADA, Scottsdale, AZ (US)

(72) Inventors: Prasanna Rao DONTULA, Bangalore (IN); Yatin TAYALIA, Singapore (SG); Upen Jayant BHARWADA, Scottsdale, AZ (US)

(73) Assignee: GENERAL ELECTRIC COMPANY, Schenectady, NY (US)

(21) Appl. No.: 13/316,011

(22) Filed: Dec. 9, 2011

(51) Int. Cl. B01D 65/00; B29C 43/24; C02F 1/44

(52) U.S. Cl. 210/541; 210/650; 264/167

(57) ABSTRACT

A feed channel spacer for use in a spiral wound membrane element provides a series of generally parallel interior channels. The interior channels extend from an inlet side of the spacer to an outlet side of the spacer, but follow an undulating or zigzagging path. Dean's vortices or other flow patterns that cause mixing reduce concentration polarization. The feed channel spacer is made by pressing a sheet of thermoplastic material in a die.

### FIELD

The present disclosure relates to spiral wound membrane elements and to feed channel spacers for spiral wound membrane elements.

### BACKGROUND

A spiral wound membrane element is manufactured by rolling one or more envelopes, each comprising two membrane sheets enclosing a permeate spacer, around a perforated central tube. Adjacent membrane sheets are separated on a feed side by a feed channel spacer, which may also be called a brine channel spacer. In use, the element is enclosed in a tubular pressure vessel. Feed water enters at an upstream end of the tubular vessel and flows across the feed spacer. A portion of the feed flows through the membrane sheets, through the permeate spacer, and out of the pressure vessel by way of the perforated central tube. The remainder of the feed water exits the feed channel as concentrate and is withdrawn from a downstream end of the pressure vessel. Multiple elements may be connected end to end in a shared pressure vessel with appropriate conduits or seals connecting the feed/concentrate and permeate sides of the elements in series.

The general requirements of a spiral wound membrane element for high performance include high permeate flow and high solute rejection with low fouling tendency. The permeate flow and solute rejection may be limited by concentration polarization (CP) on the feed side. In general terms, concentration polarization (CP) occurs as permeate passes through the membrane leaving excess material rejected by the membrane in a thin layer adjacent the feed/concentrate side of the membrane. A resistance created due to CP varies inversely with the thickness of the CP layer. One of the functions of the feed channel spacer is to generate sufficient mixing in the liquid flowing adjacent to the membrane and reduce the effect of concentration polarization.

U.S. Pat. No. 4,814,079 to Schneider discloses a spiral wound microfiltration (MF), ultrafiltration (UF), or reverse osmosis (RO) element having an open channel directed feed flow path. The flow of feed across the surface of the membrane is controlled by a feed separator which may comprise a plurality of substantially parallel separator strips of impermeable material. The open channel may include a short length of a mesh or grid strips at specified locations. The flow path provides a non-interrupted meandering path across the length and width of the surface of the membrane. A minimum traverse velocity is maintained to maintain a maximum flux rate.

US20040182774 to Hirokawa et al. discloses a spiral separation membrane element having feed side materials having warps almost parallel to the direction of flow, and wefts, thinner than the warps, at a prescribed pitch designed to reduce the pressure drop on the feed side as well as reduce clogging of the feed channel.

US20040222158 to Husain et al. discloses a membrane filtration system and method for treating water by reverse osmosis (RO), nanofiltration (NF) or ultrafiltration (UF) and a spiral wound filtration module for liquid filtration which is operated with a single pass through the feed side without cross-flow on the permeate side. The module may have dams in the spacer material on the shell/feed side to provide a path with multiple passes across the membrane leaves. The module may be internally staged, with the width of successive stages declining towards the membrane outlet, to provide a generally constant or increasing feed side velocity towards the membrane area outlet. In an embodiment disclosed, the outlet has a width and a cross-sectional area of 15% of the membrane area inlet.

Ahmad and Lau, in “Impact of different spacer filaments geometries on 2D unsteady hydrodynamics and concentration polarization in spiral wound membrane channel”, Journal of Membrane Science 286 (2006) 77-92, use computational fluid dynamics to demonstrate that a mesh spacer with strands of circular cross-section is more efficient at reducing the effect of concentration polarization than a mesh spacer with strands of rectangular cross-section.

US20070175812 to Chikura et al. discloses a spiral separation membrane element with feed spacer made of a net formed by fusion bonding.

Lau et al., “Feed spacer mesh angle: 3D modeling, simulation, and optimization based on unsteady hydrodynamic in spiral wound membrane channel”, Journal of Membrane Science 343 (2009) 16-33 use computational fluid dynamics to demonstrate an optimal included angle between the strands in a mesh-type spacer to reduce the effect of concentration polarization.

### BRIEF DESCRIPTION OF THE INVENTION

A feed channel spacer for use in a spiral wound membrane element is described in this specification. The feed channel spacer provides a series of generally parallel interior channels with curving sections in plan view. The interior channels extend from an inlet side of the spacer to an outlet side of the spacer, but follow an undulating or zigzagging path. In this way, the channels curve for most of their length.

The channels may have a generally triangular or sinusoidal cross section. The channels may have an equivalent diameter between about 0.2 mm and 1.2 mm. At least some parts of the channel may have a radius of curvature of between 1 mm and 10 mm.

Without intending to limit the invention to any particular theory of operation, the inventors believe that the channels acts as passive micro-mixers. Dean's vortices or other naturally mixing flow patterns are created in the channels. This mixing reduces concentration polarization. The spiral wound membrane element may be operated such that at least some portions of the channels have a Dean number of between 2 and 10.

The feed channel spacer is made by pressing a sheet of material in a die. The die may be in the form of a pair of grooved rollers. The material may be made of a thermoplastic material. The material is heated to its heat deflection temperature during the pressing step.

### BRIEF DESCRIPTION OF THE DRAWINGS

FIG. 1 is an oblique view of a feed channel spacer.

FIG. 2 is a schematic representation of the flow path along a channel in the feed channel spacer of FIG. 1.

FIG. 3 is a schematic representation of an alternative flow path along a channel in the feed channel spacer of FIG. 1.

FIG. 4 is a cross-section of another feed channel spacer.

### DETAILED DESCRIPTION

Feed channel spacers are used in spiral wound membrane elements to generate mixing in the feed liquid to reduce the effect of concentration polarization (CP). Once a CP layer is established, the resistance it offers to flow through the membrane varies directly with its thickness. The feed channel spacers to be described below propose to thin the CP layer over at least some portions of a membrane by providing curvature relative to the length of the spacer to promote mixing of the feed liquid. Disrupting the CP layer increases the net driving pressure (NDP) through the membrane and results in a higher permeate flow and recovery for the element.

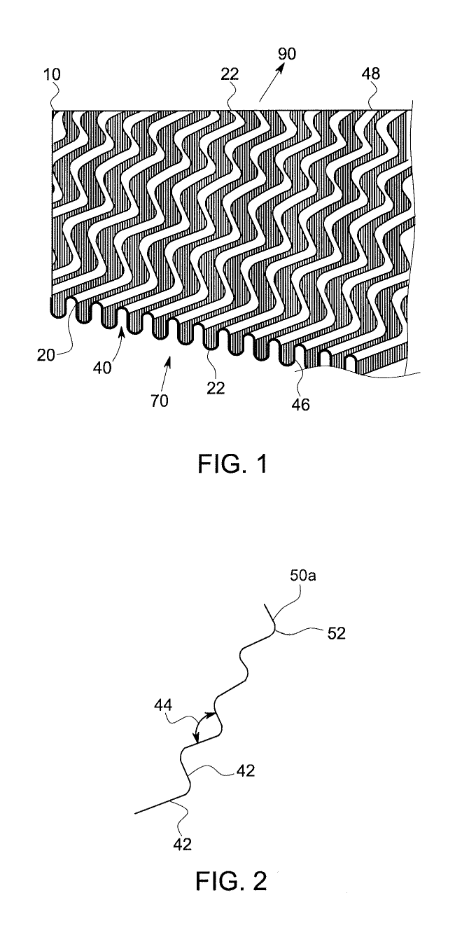

FIG. 1 depicts a feed channel spacer material 10 having a plurality of side by side, or generally parallel, interior flow channels 40 having directional changes along their length. This configuration imparts a tortuous path to feed water 70 as it flows through the feed channel spacer 10 to exit as concentrate 90. A sheet of material is formed to provide a plurality of baffles 20 that define the sides of the interior channels 40. Adjacent channels 40 are formed on alternating sides of the sheet of material. The baffles 20 in FIG. 1 comprise generally vertical baffles 20 between generally semi-circular transitional sections 22. Alternatively, the baffles 20 may be angled, sinusoidal, or according to any other cross-section that can be formed into a sheet of material. However, it is preferable for the cross section to result in short transitional sections 22 between baffles 20 since the transitional sections 22 can cover pores in the membranes.

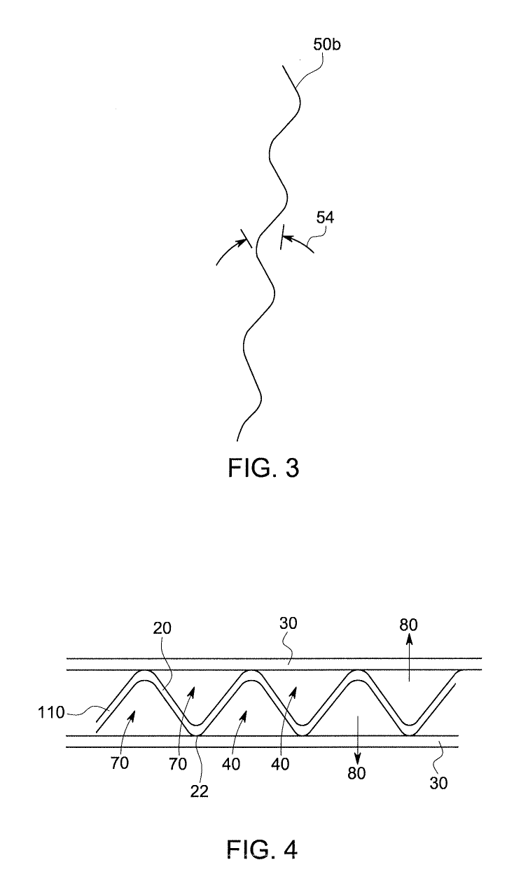

Referring to FIG. 1, FIG. 2 and FIG. 3, the feed channel spacers 10, 110 define an undulating or zigzagging path 50 between a feed inlet side 46 and a brine outlet side 48 of the feed channel spacer 10, 110. A first path 50a shown in FIG. 2 comprises a series of straight sections 42 connected by curved sections 52. An angle 44 between the straight sections may be between 30 and 150 degrees. The curved sections 52 preferably provide most, or 70% or more, of the length of the first path 50a. A second path 50b shown in FIG. 3 comprises a series of arcuate curved sections 52 with no straight sections between them. Alternatively, the arcs may be complete semi-circles, sinusoidal waves, parabolas or other curving shapes. Points of inflection may have an angle 54 relative to the general direction of the second path 50b of between 30 degrees and 90 degrees.

FIG. 4 depicts a second feed channel spacer 110 having a generally triangular or corrugated cross-section. In a spiral wound membrane envelope, the feed channel spacer 10, 110 is sandwiched between two layers of membrane 30. Permeate 80 is produced through the membrane 30. The nearly triangular cross-section of the second feed channel spacer 110 is selected to reduce the contact area between the second feed channel spacer 110 and the membrane 30. Baffles 20 extending between apexes of the cross-section define a plurality of flow passages 40. Channels 40 in the second feed channel spacer 110 have curves or other directional changes along their length as described for the feed channel spacer 10 and shown in Fig., FIG. 2 and FIG. 3.

The curvature of the interior channels 40 imparts directional changes upon the feed 70 as the feed 70 passes through the channels 40. The directional changes result in mixing, which helps reduce CP. To the extent that the curved sections 42, or portions of them, at least approximate a circular arc, a radius of curvature can be determined. At least some parts of the channels 40 may have a radius of curvature of between 1 mm and 10 mm. An equivalent diameter of the channels 40 can also be determined by calculating the diameter or a circle having the same cross-sectional area as the channels 40. Alternatively, an equivelant diameter of the channels 40 can be determined by a formula ordinarily used to determine the equivalent diameter or a non-circular cross section in Reynolds number calculations. The channels 40 may have an equivalent diameter between about 0.2 mm and 1.2 mm.

A curvature ratio for the curved sections 52 is calculated by dividing the equivalent diameter of the channels 40 by twice the radius of curvature of the curved section 52. A Dean number (De) for flow through the curved section 52 is determined by multiplying the Reynolds number, determined using the axial flow velocity (velocity along path 50) through the channels 40, multiplied by the square root of the curvature ratio. Preferably, a flow of feed water is provided through a spiral wound element having the feed channel spacer 10, 110 between two membrane sheets 30 so as to produce a Dean number of between about 2 and 10 in at least some, or at least half, or 70% or more, of the length of the path 50. In this way, Dean's vortices or other mixing flow patterns or passive micro-mixing effects may be produced in the feed water and reduce the thickness of the concentration polarization layer.

The feed channel spacer 10, 110 may be formed from a non-porous sheet of a thermoplastic material such as polypropylene. The sheet is initially flat, but the channels 40 are formed by pressing the sheet of material in a die. The die may be in the form of a pair of grooved rollers. The rollers are machined such that a ridge between grooves on one roller enters a groove in the other roller as the rollers turn. The shape of the grooves and ridges corresponds with the shape of the channels 40. One or both of the rollers are heated so that the sheet material is heated to at least its heat deflection temperature as it passes through the rollers. The channels 40 are pressed into the sheet material as it passes through the rollers, and become fixed when the sheet of material cools.

This written description uses examples to disclose embodiments of the invention, including the best mode, and also to enable any person skilled in the art to practice embodiments of the invention, including making and using any devices or systems and performing any incorporated methods. The scope of the invention is defined by the claims, and may include other examples that occur to those skilled in the art.

1. A feed channel spacer for a spiral wound membrane element comprising:
a sheet of material defining a plurality of side by side generally undulating channels extending between two opposed edges of the sheet of material wherein the undulating channels comprise curved sections along their length, and wherein the curved sections have a radius of curvature of between 1 mm and 10 mm.

2. (canceled)

3. The feed channel spacer of claim 1 wherein the plurality of side by side generally undulating adjacent channels are formed on alternating sides of the sheet of material.

4. The feed channel spacer of claim 1 wherein the undulating channels have generally triangular cross-sections.

5. The feed channel spacer of claim 1 wherein the undulating channels have an equivalent diameter between about 0.2 mm and 1.2 mm.

6. (canceled)

7. (canceled)

8. (canceled)

9. A process for filtering water comprising flowing a feed of water through a spiral would membrane element comprising a feed channel spacer according to claim 1 sandwiched between two sheets of membrane material, wherein the velocity of the water in combination with the shape of the channels produces a Dean number of between 2 and 10 in at least a portion of the channels.
